(19) United States
(12) Patent Application Publication
(10) Pub. No.: US 2025/0242819 A1
(43) Pub. Date: Jul. 31, 2025

(54) BRAKING CONTROL FOR MACHINE DESCENT

(71) Applicant: Caterpillar Inc., Peoria, IL (US)

(72) Inventors: Karl P. SCHNEIDER, Decatur, IL (US); Mahendra S. WALDIA, Oro Valley, AZ (US); Joel L. SKALET, Chillicothe, IL (US); Andrew J. OLSON, Vail, AZ (US)

(73) Assignee: Caterpillar Inc., Peoria, IL (US)

(21) Appl. No.: 18/425,374

(22) Filed: Jan. 29, 2024

(51) Int. Cl. B60W 50/04; B60W 40/10; B60W 40/13; B60W 50/00; B60W 60/00

(52) U.S. Cl. CPC B60W 50/045; B60W 40/1005; B60W 40/13; B60W 60/0025; B60W 2050/0004; B60W 2050/046; B60W 2510/184; B60W 2555/20; B60W 2556/10

(57) ABSTRACT

A system for controlling a machine includes a machine configured to travel down a slope, the machine having a braking system, a sensor configured to generate a signal that indicates travel speed of the machine or a weight of the machine, and a controller. The controller is configured to receive the travel speed signal, estimate a rolling resistance of the machine, the rolling resistance being affected by a surface on which the machine travels, update the rolling resistance of the machine over time, and set an amount of braking based on the signal and the rolling resistance estimate.

### TECHNICAL FIELD

This disclosure relates generally to machine braking control, and more particularly, to systems and methods for controlling machine braking and speed control according to rolling resistance.

### BACKGROUND

Haul trucks are used at mining sites and other worksites to transport large quantities of material. This material is typically heavy, as is the haul machine itself, which causes the machine to generate a large amount of potential energy during traveling, especially when traveling downhill. High-capacity braking systems, including mechanical systems and electric motors, allow machines to safely travel downhill while carrying material. When the braking system for a haul truck is activated, a large amount of energy can be generated, resulting in increased heat. Some machines include cooling mechanisms to dissipate heat and/or store the energy in devices, such as batteries. To avoid overheating the braking system and/or the cooling system, or exceeding the capacity of storage devices, speed can be monitored and adjusted, particularly during downhill travel to control the rate of energy transfer to the braking system.

In some situations, speed is limited during downhill travel to maintain health of the braking and cooling systems, and to ensure safety. While speed limitations have benefits, imposing overly-conservative speed limitations reduces productivity and is therefore more costly and less efficient. Overly-permissive speed limitations also create issues. For example, failure to impose sufficient speed limitations can cause increased wear on braking system components, potential damage due to overheating, or even potential safety concerns.

An exemplary method for determining vehicle resistance and motor braking performance is described in CN Patent No. 111845753B (“the '753 patent”) to Liu Huirong et al. The method described in the '753 patent includes estimating whole vehicle resistance according to conditions of the vehicle, rolling resistance that is calculated according to vehicle mass and a loading mass, air resistance, and slope resistance. The method can assist in selecting braking power of a driving system. While the method described in the '753 patent may be helpful for selecting a braking power, it is unable to account for changes to the rolling resistance, changes in temperature (e.g., component temperature, coolant temperature, ambient temperature), or other conditions. In particular, the method described in the '753 patent may be unable to account for a dynamic rolling resistance, as estimates in the '753 patent are calculated through isolated tests conducted outside of the work environment, and unable to adjust for rolling resistance changes based on location (e.g., changing conditions of the surface under the machine at different locations of work site) and time (e.g., climate-related changes to rolling resistance at a particular location).

The techniques of this disclosure may solve one or more of the problems set forth above and/or other problems in the art. The scope of the current disclosure, however, is defined by the attached claims, and not by the ability to solve any specific problem.

### SUMMARY

In one aspect, a system for controlling a machine may include a machine configured to travel down a slope, the machine having a braking system, a sensor configured to generate a signal that indicates travel speed of the machine or a weight of the machine, and a controller. The controller may be configured to receive the travel speed signal, estimate a rolling resistance of the machine according to a surface on which the machine travels, the rolling resistance being affected by a surface on which the machine travels, update the rolling resistance of the machine over time, and set an amount of braking based on the signal and the rolling resistance estimate.

In another aspect, a system for controlling a machine may include a machine configured to travel down a slope, the machine having a braking system, a sensor system including a travel speed sensor configured to generate a travel speed signal that indicates travel speed of the machine, a temperature sensor configured to generate a temperature signal that indicates a temperature, the temperature being associated with a rate of heating or a rate of cooling of the braking system, and a controller. The controller may be configured to receive the travel speed signal and the temperature signal, calculate a rolling resistance of the machine, and set an amount of braking based on the travel speed signal, the temperature signal, and the calculated rolling resistance.

In yet another aspect, a method for controlling a machine may include generating a travel speed signal with a travel speed sensor, the travel speed signal indicating a travel speed of the machine, receiving the travel speed signal with a controller for controlling braking, and calculating a rolling resistance of the machine while the machine travels downhill. The method may further include determining whether a braking capacity of a braking system of the machine exceeds a braking demand for the braking system, taking the calculated rolling resistance into account and when the braking capacity exceeds the braking demand, increasing the travel speed of the machine.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 is a partially-schematic view of an exemplary machine and machine speed control system, according to aspects of the disclosure.

FIG. 2 is a block diagram showing a configuration a controller of the machine speed control system of FIG. 1.

FIG. 3 is a block diagram illustrating a first example of control performed with the machine speed control of FIG. 1.

FIG. 4 is a block diagram illustrating a second example of control performed with the machine speed control of FIG. 1.

FIG. 5 is a block diagram illustrating a third example of control performed with the machine speed control of FIG. 1.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic. As used herein, the phrase “based on” encompasses both “based entirely on” and “based at least on.”

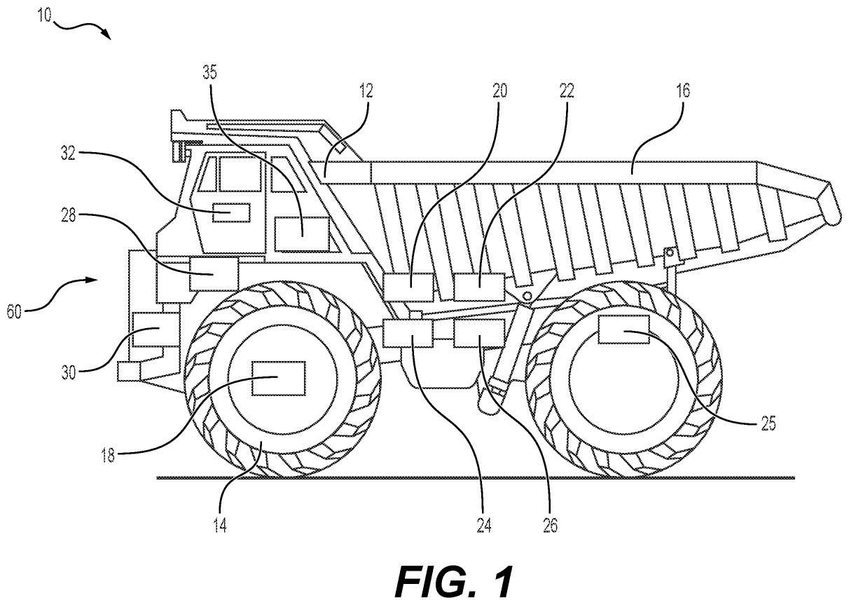

FIG. 1 is a partially schematic side view showing a machine speed control system 10 that can control machine speed by use of a braking system 18. Machine speed control system 10 may include a machine 12 and a braking capacity controller 35 for monitoring and adjusting braking system 18 of machine 12. Machine 12 may be a mobile machine configured to travel uphill and downhill. In the illustrated example, machine 12 is a haul truck (e.g., an off-highway truck, a surface mining truck, etc.). In other examples, machine 12 may be an earthmoving machine (e.g., a motor grader, excavator, or dozer), a paving machine (e.g., a cold planer), or another type of mobile machine.

Machine 12 may have one or more ground-engaging devices 14, including tracks or wheels, that enable propulsion of machine 12 at various speeds. Braking system 18 may include mechanical brakes and/or electric devices for reducing travel speed and a cooling system 20 for transferring heat from braking system 18. Machine 12 may include one or more devices for performing work, such as a haul bed 16 for containing material while machine 12 travels. Machine 12 may be configured for fully-autonomous operation in which no input is necessary during operation of machine 12, semi-autonomous operation in which some or occasional input is provided to machine 12 during operation, and/or remote operation in which some or all of the functions of machine 12 are controlled via a remote system. If desired, machine 12 may be operated manually (e.g., with an operator in a cab of machine 12) while system 10 assists with control over braking, and in some configurations displays notifications indicating an amount of available braking capacity or overrides requests from the operator to modify (e.g., reduce or increase) speed.

Braking system 18 may include a mechanical brake and/or an electrical brake. Examples of mechanical brakes include hydraulic brakes and drive train brakes (e.g., engine braking, exhaust braking, etc.). Electrical brakes may employ electrical retarding systems and, in particular, motors configured for operation as generators, electrical storage devices, and/or resistor banks for converting electrical energy to heat. Braking system 18 encompasses any of these brake types, alone or in a combination. Braking system 18 may also include energy storage devices (e.g., batteries, accumulators, and/or capacitors), torsional resistance (e.g., a hydraulic driveline retarder, engine motoring, and/or compression brakes), or electrical dissipation devices (resistor grid).

Cooling system 20 may be configured to cool one or more components of braking system 18. In the example of mechanical braking systems, cooling system 20 may supply oil or other coolant for cooling a hydraulic brake or other brake having moving parts. In the example of resistor banks or other electrical components, cooling system 20 may include blowers that direct air for convective cooling, oil or coolant supplied to moving components of the electrical systems, etc.

A sensor system 60 of system 10 may include one or more sensors useful for determining a current status of machine 12, status of braking system 18, a braking capacity of braking system 18, and conditions that affect the rate at which braking system 18 may be cooled (or the ability to slow the increase of temperature of braking system 18). Sensors of sensor system 60, as shown in FIG. 1, may include a component temperature sensor 22, an ambient temperature sensor 24, a load sensor 25, an ambient pressure sensor 26, a travel speed sensor 28, an orientation sensor 30, a payload weight sensor 31, a location sensor 32, and others. While each sensor of sensor system 60 may be a physical sensor, as understood, one or more sensors of sensor system 60 may be virtual sensors. Virtual sensors include sensors in which values are calculated or estimated based on measurements made by other (e.g., physical) sensors, based on simulations, based on previous values, or made with machine learning models. Each sensor of sensor system 60 may generate a signal that indicates a state of machine 12.

Component temperature sensor 22 may include one or more sensors for detecting a temperature of one or more components associated with braking system 18 or cooling system 20, such as a temperature of mechanical brakes and/or temperature of resistive heat elements for electrical retarding or battery temperature for regenerative retarding. Component temperature sensors 22 for cooling system 20 may include one or more coolant sensors configured to sense a temperature of coolant (e.g., oil, water, etc.) that are used for cooling braking system 18.

Ambient temperature sensor 24 may sense a temperature of the location of machine 12, such as an air temperature outside of machine 12. Ambient temperature sensor 24 may include a temperature sensor that is connected to the frame of machine 12, a weather service that provides a temperature at the location of the work site where machine 12 is operating, etc.

Load sensor 25 may sense a weight of material being carried by machine 12. Load sensor 25 may sense a pressure of hydraulic fluid associated with a hydraulic suspension of machine 12 or sense movement of the suspension.

Ambient pressure sensor 26 may sense a barometric pressure of air at the location of machine 12. Like temperature sensor 24, ambient pressure sensor 26 may be connected to the frame of machine 12 or a sensor located off-board of machine 12.

Travel speed sensor 28 may sense a movement speed of machine 12 along a travel path. This speed may be detected based on rotation of one or more wheels of one or more ground-engaging devices 14, one or more tracks of one or more ground-engaging devices 14, speed of one or more transmission elements, acceleration and deceleration of machine 12, global navigation satellite system (“GNSS”) sensors (e.g., a Global Positioning System sensor), ultrasonic speed sensors, or optical sensors.

Orientation sensor 30 may sense an orientation (e.g., upward or downward) of machine 12 itself, which may be caused by the slope, also referred to as grade, of the ground on which machine 12 is located. Orientation sensor 30 may be one or more inertial measurement units (“IMUs”).

Location sensor 32 may sense a location (e.g., a geographic location) of machine 12. This location may be used by braking capacity controller 35 to correlate a current location of machine 12 with a distance and grade associated with one or more downhill segments along which machine 12 is expected to travel. Location sensor 32 may include GNSS sensors or a ground-based location system.

Braking capacity controller 35 may be programmed to control one or more aspects of system 10, including controlling braking system 18 of machine 12. For example, controller 35 may be configured to monitor and control vehicle speed (e.g., by setting a travel speed limit for machine 12) based on a present amount of braking system capacity, while accounting for changes in load, grade, and rolling resistance. Controller 35 may generate signals for causing machine 12 to travel at a desired speed and actuate braking system 18 to achieve this desired speed. Controller 35 may be configured for electronic control of a steering mechanism, an internal combustion engine, electric motor, battery system, fuel cell, or other power-generating device, as well as a power-transmitting device such as a transmission.

Controller 35 may encompass a single control unit that controls one or more aspects of machine 12 such as braking system 18, cooling system 20, other aspects of the braking system, propulsion, steering, a hydraulic system for operating an implement, or other aspects of machine 12. In some configurations, controller 35 is distributed as a plurality of individual controllers. As used herein, a “controller” encompasses both single controllers or control modules, or a plurality of controllers or control modules. While controller 35 is described as being a controller on-board machine 12 (e.g., traveling with machine 12), controller 35 may encompass one or more devices or functions performed off-board of machine 12. For example, controller 35 may transmit determined rolling resistance values (e.g., associated with one or more geographic locations) to an off-board system where this data may be stored as historical data, described below, for use when another machine 12 travels at the same location. Controller 35 may be enabled, via programming, to receive signals from sensors of sensor system 60 as well as other sensors of machine 12. In particular, controller 35 may be configured, via programming, to receive signals from sensors of system 60, determine a rolling resistance, the force acting opposite to the direction of travel of machine 12 due to friction between ground-engaging devices 14 and the ground surface, compaction of material, and heat generation from tire deformation, update the rolling resistance over time, determine a rate at which braking system 18 may be cooled, and control braking system 18 based on these signals and determinations.

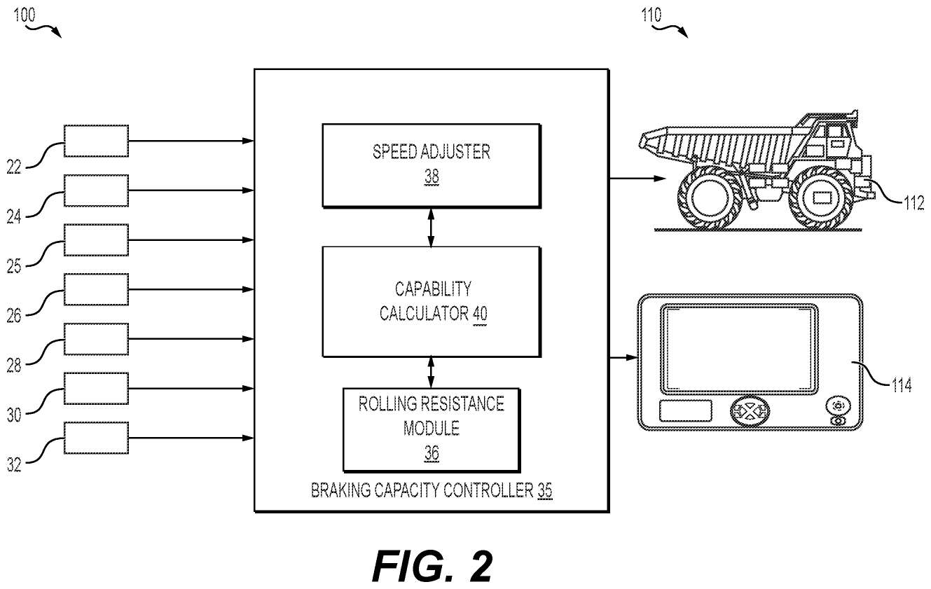

Controller 35 may embody a single microprocessor or multiple microprocessors that receive inputs and generate outputs. Controller 35 may include a memory, a secondary storage device, a processor such as a central processing unit, or any other means for accomplishing a task consistent with the present disclosure. The memory or secondary storage device associated with controller 35 may store data and software to allow controller 35 to perform its functions, including the functions described with respect to FIGS. 2-5. Numerous commercially available microprocessors can be configured to perform the functions of controller 35. Various other known circuits may be associated with controller 35, including signal filtering and analysis circuitry, command generation circuitry, communication circuitry, and other appropriate circuitry.

FIG. 2 is a block diagram illustrating an exemplary configuration of controller 35 and other components of machine speed control system 10. As shown in FIG. 2, controller 35 may include a speed adjuster 38, a rolling resistance module 36, and a capability calculator 40. Controller 35 may also receive inputs 100 and generate one or more outputs 110. Inputs 100 may indicate conditions that impact braking capacity of machine 12, the ability of cooling system 20 to cool braking system 18, ambient conditions that impact the effectiveness of cooling system 20 and that impact the rate at which braking system 18 takes in energy (e.g., as heat), etc. Outputs 110 may include brake commands 112 for actuating braking system 18 and controlling the speed of machine 12 while traveling downhill. Outputs 110 may also include brake notifications 114, which are described below.

Inputs 100 may include signals from each sensor, sensors 22-32 of sensor system 60. These signals may identify temperatures of components associated with braking system 18, ambient conditions, the travel speed of machine 12, the location of machine 12, the weight of material carried by machine 12, and others. Each of these signals from sensors 22-32 may correspond to the descriptions of the sensors of sensor system 60 above.

Speed adjuster 38 may receive inputs 100 and generate brake commands 112 that actuate mechanical or electrical components of braking system 18. Speed adjuster 38 may be configured to determine whether a current speed is below a target speed or above the target travel speed, the desired speed being realized via braking when machine 12 travels downhill. The target speed may be set by speed adjuster 38 to maximize productivity without introducing disadvantages associated with exceeding capacity of braking system 18 (e.g., by overspeeding). The target travel speed set with speed adjuster 38 may be determined by calculating and updating the rolling resistance of machine 12 over time. The travel target speed may also take into account ambient conditions, including ambient temperature or pressure, as described below.

In some aspects, the travel target speed generated with speed adjuster 38 operating in conjunction with capability calculator 40 takes into account information relating to the a travel path, including distance and grade of one or more downhill segments along which machine 12 is currently travelling or expected to travel in the future. Changes in the travel path of machine 12 may be accounted for by updating a rolling resistance that is stored as historical data, as described below). For example, speed adjuster 38 may be configured to project braking capacity, and adjust speed, based on the distance of a current or upcoming downhill segment, the grade(s) associated with the downhill segment, and historical information, including rolling resistance, associated with prior travel along the downhill segment by machine 12 itself or by another machine.

Commands 112 may enable propulsion of machine 12 at a desired travel speed by preventing overspeed of the braking capability of braking system 18. Brake commands 112 may also prevent under-application of brakes in situations where it is desirable to reduce the speed of machine 12. Commands 112 may correspond to instructions generated while machine 12 operates manually, in a fully-autonomous mode, or in a semi-autonomous mode. These commands 112 may be different than, and in some cases may override, a braking request generated by an operator when machine 12 operates remotely or via commands issued from a cab of machine 12. For example, commands 112 may override commands from an operator when additional braking is necessary to achieve the target travel speed.

Capability calculator 40 may determine the braking capacity of machine 12. Braking capacity may refer to an amount of braking that can be applied without generating heat that exceeds a predetermined temperature or power that exceeds the capacity of braking system 18. The braking capacity may be an instantaneous braking capacity (e.g., a maximum amount of braking force that can be applied immediately, based on present conditions, without exceeding capacity, for example causing an overheating condition, of braking system 18) or a projected braking capacity that can be applied for a certain period of time (e.g., a period of time associated with travel across a downhill segment). In some configurations, capability calculator 40 determines both instantaneous and projected capacities. As examples, braking system 18 may have time-dependent capacities due to initial conditions and thermal inertia, as well as other limitations, such as battery current limits associated with a particular charge level, etc.

The braking capacity of machine 12 may be determined based on map data (e.g., data representing hill slope or grade, and distance, at the worksite where machine 12 operates), physics-based models (e.g., models representing different systems of machine 12, including braking systems, cooling systems, including the impacts of ambient temperature, ambient pressure, travel speed, torque or power requests, etc. on the ability of braking system 18 to cool), and component limits (e.g., constraints associated with maximum permissible conditions, such as maximum temperatures or maximum braking power).

Rolling resistance module 36 may determine a current rolling resistance as machine 12 travels downhill and updates the rolling resistance over time. Rolling resistance module 36 may also be configured to generate predicted future rolling resistances, in at least some configurations. Capability calculator 40 may receive inputs 100 to generate current and projected future rolling resistance values. For example, capability calculator 40 may calculate rolling resistance based on signals from travel speed sensor 28, orientation sensor 30, weight sensor 31, and location sensor 32.

Capability calculator 40 may be configured to output the rolling resistance and/or braking capacity to speed adjuster 38. Exemplary interactions between speed adjuster 38 and capability calculator 40 are described in greater detail below. Capability calculator 40 may also output brake notifications 114 to, for example, a display within a cabin of machine 12, a display of a mobile device used by an operator of machine 12 such as a computer, laptop, cellular phone, tablet, system for remote control of machine 12, or other device configured to generate visual or audio notifications. Brake notifications 114 may be based on the amount of available braking or a difference between current speed and the target travel speed. In particular, brake notifications 114 may indicate the difference between current brake capacity and current brake demand, representing the ability to increase speed without exceeding brake capacity.

### Industrial Applicability

System 10 may be useful in any machine 12 which travels downhill, unloaded or while carrying material. System 10 may be employed in machines that are operated manually (on-site or remotely), semi-autonomously, or fully-autonomously. System 10 may operate continuously or periodically, monitoring rolling resistance over time. System 10 may update braking demand and/or braking capacity based on the current rolling resistance. System 10 may modify the amount of activation (also referred to as “actuation”) of braking system 18 based on the current rolling resistance, and may also take the ability of cooling system 20 to cool braking system 18 into account.

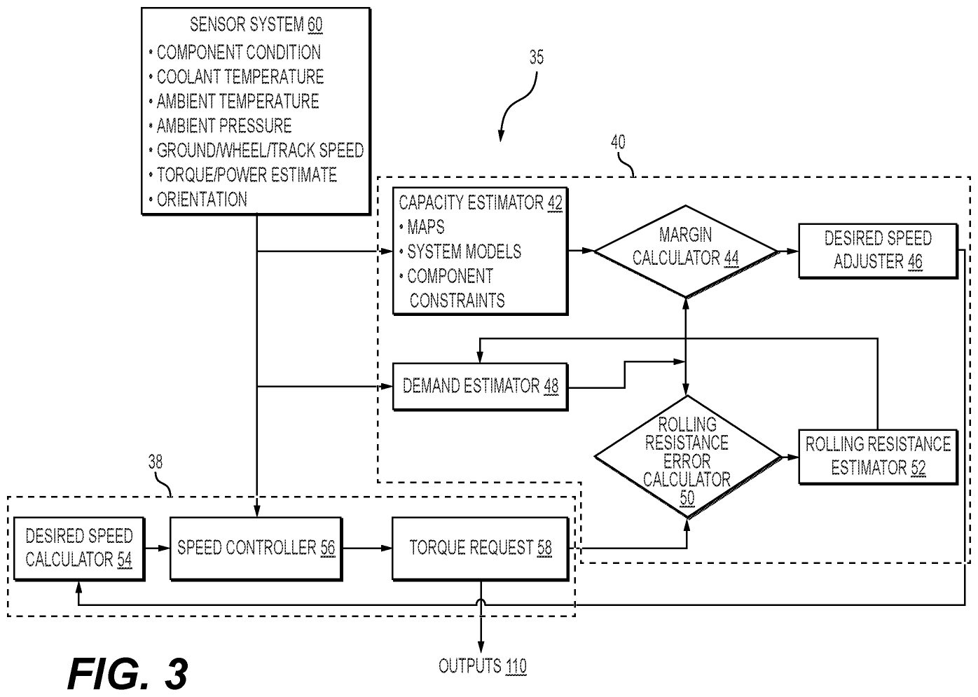

Exemplary configurations of controller 35 of system 10 are represented by the flowcharts in FIGS. 3-5. FIGS. 3-5 are flowcharts that represent components of system 10 and operations performed with controller 35. In FIG. 3, operations that may be performed with speed adjuster 38 and capability calculator 40, respectively, are indicated within respective dashed-line boxes. Capability calculator 40 may include a capacity estimator 42, a margin calculator 44, a desired speed adjuster 46, a demand estimator 48, a rolling resistance error calculator 50, and a rolling resistance estimator 52. Speed adjuster 38 may include a desired speed calculator 54 and a speed controller 56, and may generate a torque request 58.

Sensor system 60 of system 10 may provide outputs to speed adjuster 38 and capability calculator 40, these outputs corresponding to inputs 100 described with respect to FIG. 2. With reference to the examples shown in FIG. 3, sensor system 60 may generate signals for component conditions (e.g., weight from sensor 31 and/or components temperatures), coolant temperatures, ambient temperatures, travel speed (e.g., ground speed, wheel speed, or track speed), torque or power estimates that represent a current output of an engine, motor, fuel cell, battery, etc., of machine 12, or an orientation representing the present slope. Signals from sensor system 60 may be received by capacity estimator 42, demand estimator 48, and speed controller 56.

Capacity estimator 42 may calculate a braking capacity of machine 12 that represents the maximum amount of available braking power that will not cause an overheating condition of braking system 18. This capacity may represent instantaneous braking capacity or a projected braking capacity, and may be output in the form of a torque request. Capacity estimator 42 may estimate braking capacity and output the torque request based on maps (e.g., look-up tables) that provide capacity estimator 42 with braking capacity values for various conditions reflected by signals from sensor system 60 (e.g., signals from ambient temperature sensor 24, ambient pressure sensor 26, or component temperature sensor 22 that represent a cooling capacity of the braking system), system models that predict the behavior of systems of machine 12, and constraints associated with maximum permissible conditions, such as maximum temperatures or maximum braking forces or maximum power or electrical current for current conditions.

The system models or other components of capacity estimator 42 may enable use of the component temperatures, coolant temperatures, ambient temperatures, and ambient pressures to determine the rate at which energy will accumulate in the braking system when braking system 18 are actuated by a particular amount. For example, lower ambient temperatures decrease the rate at which the braking system warms and may also increase the effectiveness of cooling system 20, increasing cooling capacity. The ambient pressure may also impact the rate at which heat is retained, with lower pressures (e.g., due to higher altitude) reducing the effectiveness of cooling system 20 and/or reducing the rate at which braking system 18 themselves are cooled, resulting in a decrease in cooling capacity. The braking capacity output by capacity estimator 42 may increase with increasing cooling capacity, allowing controller 35 to increase the target travel speed with increased ability to cool braking system 18.

Demand estimator 48 may determine a current braking demand associated with the braking system. Demand estimator 48 may calculate this estimation based on current grade, weight of material carried by machine 12, travel speed, acceleration, and the estimated current or future rolling resistance. The estimated demand may reflect the amount of braking required by braking system 18 under current conditions (e.g., to achieve target travel speed.

Margin calculator 44 may receive the capacity from capacity estimator 42 and the demand from demand estimator 48. Margin calculator 44 may calculate the difference between the capacity and the demand to determine an amount of margin. This margin may be output to desired speed adjuster 46.

The margin from margin calculator 44 may be output to desired speed adjuster 46. The margin may correspond to a reduction in the amount of braking, or an amount of additional speed, that is available for use. Thus, desired speed adjuster 46 may calculate a desired speed value based on the margin. This speed may increase productivity without introducing safety risk, increased wear, and/or risk of overheating. The margin calculated with margin calculator 44 may be output to desired speed calculator 54 of speed adjuster 38.

Rolling resistance estimator 52 may estimate current rolling resistance and output the estimated rolling resistance for use by demand estimator 48. The rolling resistance may be calculated based on current conditions of machine 12, including weight, acceleration, current grade, and drivetrain losses. In some examples, rolling resistance may be calculated continuously (e.g., in real-time) or periodically by rolling resistance estimator 52, such that the rolling resistance is updated for various segments (e.g., portions of one or more hills having different grades and/or ground conditions) of a work cycle.

Rolling resistance error calculator 50 may determine a difference between the torque request 58 (described below) and the braking demand from demand estimator 48. As an example, when a rolling resistance estimate should be updated, the output of demand estimator 48 may deviate from the torque request from capacity estimator 42. This difference causes speed to be adjusted based with margin calculator 44. When the difference is unexpected (e.g., when torque request and demand are not equivalent), this difference may be reflected by an error output with rolling resistance error calculator 50. This error may further correspond to the difference between a current speed and an expected speed (e.g., the difference between the target travel speed corresponding to torque request 58, which takes the estimated rolling resistance into account, and the actual ground/wheel/track speed output by sensor system 60). This error may be output to rolling resistance estimator 52 and used to increase the accuracy of subsequent rolling resistance estimations.

Desired speed calculator 54 may be configured to receive the desired speed adjustment generated with desired speed adjuster 46 of capability calculator 40. Desired speed calculator 54 may adjust the target travel speed, for example increasing speed based on the margin determination made by margin calculator 44, and output the speed to speed controller 56. Speed controller 56 may generate commands for achieving the target travel speed by proportional-integral-derivative control or another suitable method. In particular, speed controller 56 may output a torque request 58 that reflects the target travel speed from desired speed calculator 54.

Torque request 58 may correspond to brake commands 112 (FIG. 2) or another output 110. During downhill travel, torque request 58 may be a negative value representing, for example, the amount of deceleration necessary to achieve the target travel speed. Torque request 58 may be output to rolling resistance error calculator 50 for use in the above-described error calculation.

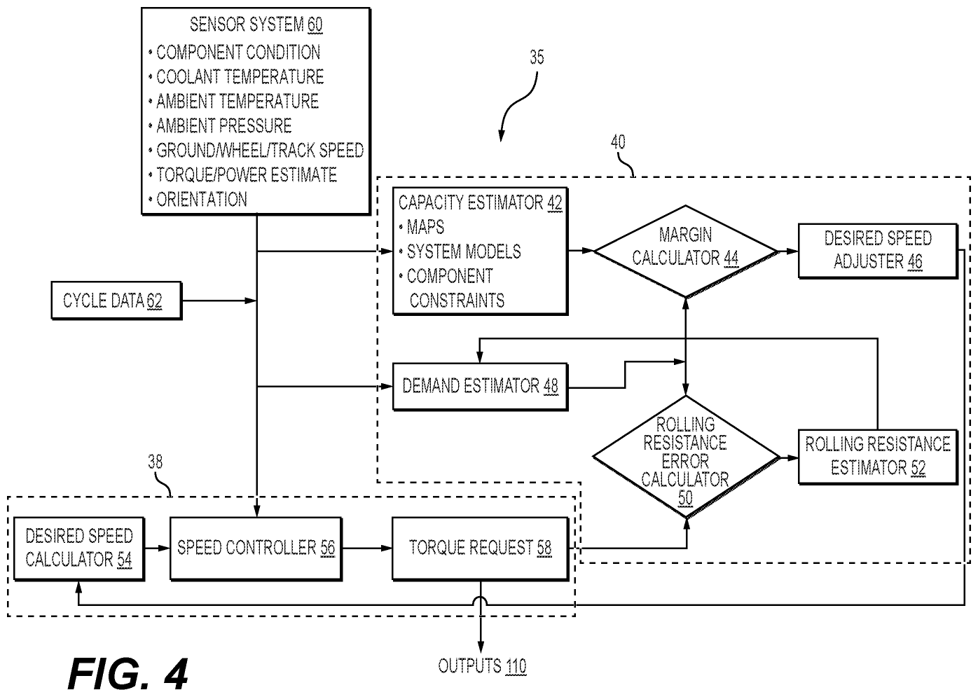

FIG. 4 is a flowchart illustrating another exemplary configuration of controller 35. Elements represented in FIG. 4 that differ from those of FIG. 3 are described below.

In FIG. 4, controller 35 is configured with memory storing cycle data 62. Cycle data 62 may include information (e.g., grade and distance information, as well as rolling resistance data for previous cycles) that corresponds to one or more downhill segments that machine 12 is traversing or is expected to traverse. This may allow controller 35 to identify values for the length of a downhill segment and the grade, these values being stored in advance and retrieved based on the current location of machine 12 identified with location sensor 32. Cycle data 62 may be output to both capability calculator 40 and demand estimator 48 to allow capacity estimator 42 and demand estimator 48 to use cycle data 62 when estimating capacities and demands, respectively. Capability calculator 40 may take into account initial conditions (e.g., initial component and/or system states, such as temperature that reflect the ability to warm up the component or the system beyond a steady state capacity), and time (e.g., time to complete the current downhill segment or a future downhill segment) based on data 62. Demand estimator 48 may take segment distance or time to travel a segment from data 62 into account when generating demand estimations.

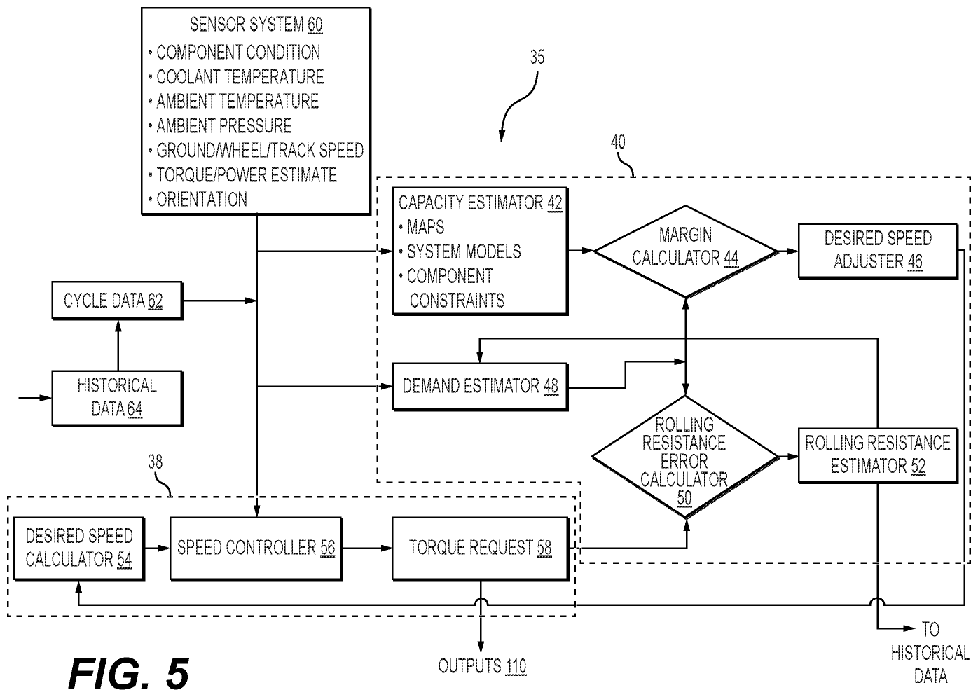

FIG. 5 is a flowchart illustrating another exemplary configuration of controller 35. Elements represented in FIG. 5 that differ from those of FIGS. 3 and 4 are described below.

As shown in FIG. 5, controller 35 may be configured with processed historical data 64. Historical data 64 may include data sensed by machine 12 or another machine 12 (e.g., data from an external dispatch and/or supervisory system in communication with controller 35) during prior operation (e.g., information associated with one or more downhill segments during prior work cycles). Each segment represented in historical data 64 may be associated with a respective rolling resistance, the rolling resistance for each segment having been generated with rolling resistance estimator 52. Thus, past rolling resistance values may be used to adjust future rolling resistance estimations and to determine future capacity and demand estimates.

Machine learning models may be trained based on historical data 64 to output a rolling resistance for a current and/or future location of machine 12. Machine learning models for analysis of historical data 64 may include a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods. These machine learning models may, for example, be performed via a dispatch or other remote system configured to aggregate data from multiple machines (e.g., a fleet of machines) and process this data for use in machine 12 for use during currently deployment (e.g., in real time).

In some aspects, historical data 64 is generated and/or stored with the use of an off-board system. Off-board systems (e.g., computing systems that are not physically located on machine 12) may provide additional functionality, such as the use of machine learning models. Off-board systems may further provide the ability to receive rolling resistance data transmitted by a plurality of different machines 12 and to apply statistical or other analyses to arrive at average or otherwise representative values of rolling resistance for one or more particular locations. While machine learning models or other aspects of historical data 64 and cycle data 62 may be performed with off-board systems or off-board functions of controller 35, as understood, each of the above-described functions may be performed by a suitably configured controller 35 onboard machine 12.

In some aspects, a method for controlling machine 12 may be performed with system 10 as described above with respect to FIGS. 3-5. Methods of controlling machine 12 may include generating a travel speed signal with travel speed sensor 28, this signal indicating a travel speed of machine 12 during downhill travel. Controller 35 may receive this speed signal and calculate the current rolling resistance with rolling resistance estimator 52. Rolling resistance may be output from rolling resistance estimator 52 and used by demand estimator 48 to estimate braking demand. Margin calculator 44 of controller 35 may identify when braking capacity of machine 12 exceeds the braking demand. When margin exists, travel speed of machine 12 may be increased by reducing the amount of braking indicated by commands 112 for braking system 18. If desired, brake notifications 114 may be issued based on the existence of margin or the need to increase braking.

The disclosed system and method may take changes in rolling resistance into account, allowing for accurate prediction of the amount of braking that is available for a machine traveling downhill. This amount of braking may allow for increased speed and productivity without risk of braking system overheating during travel or should a stop be necessary. Changes in rolling resistance are identified, while prior rolling resistances and/or the error between an estimated rolling resistance and an actual rolling resistance may be used to increase the accuracy of future calculations. The ability to safely increase speed may improve productivity, increasing the value of the machine equipped with system 10.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A system for controlling a machine, the system comprising:
a machine configured to travel down a slope, the machine having a braking system;
a sensor configured to generate a signal that indicates travel speed of the machine or a weight of the machine; and
a controller configured to:
receive the travel speed signal,
estimate a rolling resistance of the machine, the rolling resistance being affected by a surface on which the machine travels,
update the rolling resistance of the machine over time, and
set an amount of braking based on the signal and the rolling resistance estimate.

2. The system of claim 1, wherein the rolling resistance estimate is updated based on present conditions of the machine and the surface on which the machine travels.

3. The system of claim 1, further including a location sensor, the controller being configured to update the rolling resistance estimate based on a geographic location of the machine detected with the location sensor.

4. The system of claim 1, wherein the controller is configured to increase a speed of the machine down the slope when the rolling resistance estimate increases.

5. The system of claim 1, wherein the controller is configured to increase a speed of the machine based on an increase in cooling capacity.

6. The system of claim 5, wherein the increased cooling capacity is identified with an ambient temperature sensor, an ambient pressure sensor, or a component temperature sensor, and with a map or physics-based model.

7. The system of claim 1, wherein the controller is configured to update the amount of braking based on distance and grade information stored for an upcoming travel path and identified based on a signal from a location sensor.

8. The system of claim 1, wherein the controller is configured to change the travel speed based on historical rolling resistance estimate for an upcoming travel path.

9. The system of claim 1, wherein the a weight sensor configured to generate a weight signal that indicates a weight of material carried by the machine, the controller being configured to update the rolling resistance estimate based on the weight signal.

10. A system for controlling a machine, the system comprising:
a machine configured to travel down a slope, the machine having a braking system;
a sensor system including:
a travel speed sensor configured to generate a travel speed signal that indicates travel speed of the machine;
a temperature sensor configured to generate a temperature signal that indicates a temperature, the temperature being associated with a rate of heating or a rate of cooling of the braking system; and
a controller configured to:
receive the travel speed signal and the temperature signal,
calculate a rolling resistance of the machine, and
set an amount of braking based on the travel speed signal, the temperature signal, and the calculated rolling resistance.

11. The system of claim 10, wherein the temperature signal indicates temperature of coolant, ambient temperature, or temperature of a component of the machine.

12. The system of claim 10, wherein the controller is configured to update the calculated rolling resistance based on changes in location of the machine.

13. The system of claim 10, wherein the controller is configured to determine a braking demand of the machine.

14. The system of claim 13, further including a location sensor configured to generate a location signal that indicates a location of the machine, the controller being configured to update the determined braking demand based on the location.

15. The system of claim 10, wherein the controller is further configured to transmit the rolling resistance to an off-board system for storage as historical data configured for use when another machine travels down the slope.

16. A method for controlling a machine, the method comprising:
generating a travel speed signal with a travel speed sensor, the travel speed signal indicating a travel speed of the machine;
receiving the travel speed signal with a controller for controlling braking;
calculating a rolling resistance of the machine while the machine travels downhill;
determining whether a braking capacity of a braking system of the machine exceeds a braking demand for the braking system, taking the calculated rolling resistance into account; and
when the braking capacity exceeds the braking demand, increasing the travel speed of the machine.

17. The method of claim 16, wherein the calculated rolling resistance is updated during operation of the machine.

18. The method of claim 16, wherein the braking capacity is determined based on a cooling capacity associated with the braking system.

19. The method of claim 16, wherein the braking capacity is determined based on at least one of ambient temperature or ambient pressure.

20. The method of claim 16, further including updating the calculated rolling resistance based on information stored for an upcoming downhill travel path.
